(19) United States
(12) Patent Application Publication
(10) Pub. No.: US 2007/0083920 A1
(43) Pub. Date: Apr. 12, 2007

(54) Software providing method, software providing system, terminal apparatus and software obtaining method

(75) Inventors: Tetsuya Mizoguchi, Tokyo (JP); Masayuki Sato, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: MOBILE BROADCASTING CORPORATION, Tokyo (JP)

(21) Appl. No.: 10/574,921

(22) PCT Filed: Sep. 22, 2004
(86) PCT No.: PCT/JP04/13792

§ 371 Date: Jun. 22, 2006

(30) Foreign Application Priority Data
Oct. 9, 2003 (JP) 2003-351176

(51) Int. Cl. H04L 9/32

(52) U.S. Cl. 726/9

(57) ABSTRACT

[Summary][Object]To allow large capacity and high quality software to be downloaded at low cost and high speed. [Means for Solving]

In a system that allows only a user terminal 3 that has been authenticated with authentication information to watch a program broadcast from a broadcasting station 1, it broadcasts software that the user terminal 3 needs to download along with the authentication information of the user who needs to download the software. When the user terminal 3 has been authenticated, it downloads the software.

### FIELD OF THE INVENTION

The present invention relates to a system of which a broadcasting station and a user side terminal can communicate each other, in particular, to a software providing method, a software providing system, a terminal apparatus, and a software obtaining method that allow the terminal apparatus to download software and update the version of the software.

### BACKGROUND OF THE INVENTION

When a user downloads software to an electronic device such as a PC (Personal Computer), he or she buys a recording medium such as a CD-ROM (Compact Disc—Read Only Memory) at a shop and installs software stored on the recording medium to the electronic device. Instead, a software vendor allows its user who is contracted to download software to his or her electronic device through the Internet. When functions of the software that has been installed to an electronic device are enhanced or bugs of the software are corrected, the software vendor sends a recording medium such as a CD-ROM that stores an upgraded file to individual users or allows the users who are contracted to download the upgraded file to their electronic device through the Internet (see for example Patent Document 1).
Patent Document 1: Japanese Patent Application Unexamined Publication No. 2002-099479 (FIG. 1, etc.)
   Disclosure of the Invention
   Problems to be Solved

However, when software is upgraded with a recording medium, not only the recording medium costs the software vendor some money, but it takes the software vendor a distribution time. In addition, inventory control (version control) on a distribution channel is required. On the other hand, when software is upgraded through the Internet, since information needs to be bidirectionally transmitted and received between the user and the software vendor, a communication time is required. When the user does not have a broadband environment for the Internet, it takes a long download time. In addition, the user's device is exposed to viruses through the Internet. When a user who bought software may not have done the user registration, even if it upgrades the software, the software vendor may not identify him or her.

In addition, a user needs to check if an upgraded file matches his or her device. If the user is not familiar with the upgrade operation, he or she may improperly download the file to his or her device. The software vendor checks if the upgraded file works as the software vendor expected with information through telephone, facsimile, letter, and so forth from the user. Thus, the software vendor cannot check the operation of the upgraded file in real time.

From the foregoing point of view, an object of the present invention is to provide a software providing method, a software providing system, a terminal apparatus, and a software obtaining method that allow large capacity and high quality software to be downloaded at low cost and high speed.

Means for Solving the Problem

To accomplish the foregoing object, a major aspect of the present invention is a software providing method for a system of which a broadcasting station broadcasts a program along with authentication information with which each user is authenticated for a viewing license and a user terminal that has the authentication information reproduces a received program with the authentication information, the method comprising the steps of: causing the broadcasting station to broadcast software that the user terminal needs to download along with the authentication information of the user; and causing the user terminal that needs to download the software to download the received software with the authentication information of the user.

Another aspect of the present invention is a software providing system of which a broadcasting station broadcasts a program along with authentication information with which each user is authenticated for a viewing license and a user terminal that has the authentication information reproduces a received program with the authentication information, wherein the broadcasting station comprises: broadcasting means for broadcasting software that the user terminal needs to download along with the authentication information of the user, and wherein the user terminal comprises: receiving means for receiving a broadcast program along with the software and the authentication information with which the software is downloaded; and downloading means for downloading the software with the authentication information of the user.

Another aspect of the present invention is a terminal apparatus that receives a program along with authentication information with which each user is authenticated for a viewing license from a broadcasting station and reproduces the program with the authentication information, comprising: storing means for pre-storing the authentication information; receiving means for receiving a broadcast program along with software and the authentication information from the broadcasting station; collating means for collating the authentication information stored in the storing means with the authentication information received by the receiving means; and downloading means for downloading the software received by the receiving means corresponding to the collating result of the collating means.

In these structures, authentication information with which a viewing license of a user is authenticated is also used as authentication information with which a software download license is authenticated. A user who has the authentication information can download software through a broadcast. Thus, unlike with information bidirectionally exchanged through the Internet, information can be one-directionally transmitted. As a result, large capacity and high quality software can be downloaded at low cost and high speed. When the user has the authentication information, software can be passively downloaded along with a received broadcast program. Thus, since the user is freed from a troublesome download work, the convenience is improved. In addition, since software is transmitted through a broadcast, there is no risk of which the user terminal is exposed to viruses.

The software may be application software, an upgraded file of an operating system, and an upgraded file of firmware of the terminal. According to the present invention, various types of software can be safely downloaded.

The broadcasting station may broadcast the software so that the user terminal can download the software without the authentication information when the broadcasting station provides free software. In this structure, when the software provider provides free software, since the authentication information is not required, the authentication process can be omitted. Thus, the user can smoothly download the software.

The broadcasting station may broadcast the software that the user terminal needs to download along with the authentication information of the user and information about an address of a software provider. The user terminal may judge whether the broadcasting station has broadcast the program along with the information of the address of the software provider and when the judged result denotes that broadcasting station has broadcast the program along with the information of the address of the software provider, the user terminal may transmit prejudged information to the address of the software provider. In this structure, when the program is broadcast along with the information about the address of the software provider, the user terminal transmits the prejudged information to the software provider. Thus, before and after the user downloads the software, he or she can share information about himself or herself and information about the user's terminal with the software provider. As a result, the user can more accurately and smoothly download the software than before.

The information of the address of the software provider may be information about a dial number of a cellular phone or a network address (URL: Uniform Resource Locator or mail address). In this structure, the user transmits the prejudged information to the cellular phone of the software provider or a prejudged location of a web server or a mail server of the software provider. As a result, the user can more accurately and smoothly download the software than before.

The prejudged information may be information about a storage capacity for storing the downloaded software, information about a version of the software, information about an operation state of the software that has been downloaded, and information about user's satisfaction for the software that has been downloaded. In this structure, the information about the storage capacity is transmitted. As a result, the user can securely allocate a capacity necessary for downloading the software. As a result, the user can safely download the software. Since the version information of the software that the user is using is transmitted, he or she can know whether the software of his or her terminal should be upgraded. When necessary, the user can download an upgraded file. In addition, the information about the operation state of the terminal after the software has been downloaded is transmitted. Thus, the software provider can smoothly deal with bugs of the software that has been downloaded. In addition, when the user transmits information about user's satisfaction of the downloaded software to the software provider, it can improve customer services.

The present invention is a software providing method for a system of which a broadcasting station broadcasts a program along with authentication information with which each user is authenticated for a viewing license and a user terminal that has the authentication information reproduces a received program with the authentication information, the method comprising the steps of: causing the broadcasting station to broadcast the authentication information of the user that allows him or her to load the software or data from a server that stores the software or the data to the user terminal and to use the software or data; and causing the user terminal to load the software or data from the server with the authentication information of the user broadcast from the broadcasting station so that the user terminal can use the software or data.

The present invention is a terminal apparatus that receives a program along with authentication information with which each user is authenticated for a viewing license from a broadcasting station and reproduces the program with the authentication information, comprising: storing means for pre-storing the authentication information; receiving means for receiving the authentication information from the broadcasting station; collating means for collating the authentication information stored in the storing means with the authentication information received by the receiving means; and loading means for loading software or data from a server that stores the software or data corresponding to the collating result of the collating means.

Here, the term “data” is for example data of an address of the software provider. Specifically, the data is information about a dial number of a cellular phone or a network address of the software provider. The term “load” means all operations that the user terminal accesses the server and obtains the software or the data therefrom. The server that stores the software or the data is disposed on other than the broadcasting station, for example on the software provider side. The server of the software provider and the user terminal may communicate with each other through a network.

The user terminal may not load the software or the data from the server. Instead, when authentication information stored in the user terminal matches authentication information that the user terminal has received, an information device connected to the user terminal may load the software or data from the server and store the software or data to a storage unit of the information device. In other words, in this case, the user terminal authenticates the viewing license for the broadcast program. In addition, the user terminal authenticates a software loading license for the information device. When the user terminal has successfully authenticated the licenses, it allows the user to watch the broadcast program and the information device to download the software. The information device is for example a PC (Personal Computer), a PDA (Personal Digital Assistants), or a cellular phone. The storage unit may be a hard disk, a main storage unit such as a DRAM (Dynamic Random Access Memory), or a cash memory such as an SRAM (Static Random Access Memory).

Another aspect of the present invention is a software providing method for a system of which a broadcasting station broadcasts a program along with authentication information with which each user is authenticated for a viewing license and a user terminal that has the authentication information reproduces a received program with the authentication information, the method comprising the steps of: causing the broadcasting station to broadcast the authentication information of the user that allows him or her to load the software or data from a removable medium that stores the software or the data to the user terminal and to use the software or data; and causing the user terminal to load the software or data from the removable medium with the authentication information of the user broadcast from the broadcasting station so that the user terminal can use the software or data.

Another aspect of the present invention is a terminal apparatus that receives a program along with authentication information with which each user is authenticated for a viewing license from a broadcasting station and reproduces the program with the authentication information, comprising: storing means for pre-storing the authentication information; receiving means for receiving the authentication information from the broadcasting station; collating means for collating the authentication information stored in the storing means with the authentication information received by the receiving means; and loading means for loading software or data from a removable medium that stores the software or data corresponding to the collating result of the collating means.

The removable medium is for example an optical or magnetic disk such as a CD-ROM, an FD (Floppy (registered trademark) Disk), a DVD (Digital Versatile Disk), or an MO (Magneto Optical disk). The software or the data stored on the removable medium is loaded through a device such as a removable disk drive.

The user terminal may not load the software or the data from the removable medium. Instead, when authentication information stored in the user terminal matches authentication information that the user terminal has received, an information device connected to the user terminal may load the software or data from the removable medium and store the software or data to a storage unit of the information device.

The present invention is a method of obtaining software with a terminal apparatus that receives a program along with authentication information with which each user is authenticated for a viewing license from a broadcasting station and reproduces the program with the authentication information, the method comprising the steps of: pre-storing the authentication information; receiving a broadcast program along with software and the authentication information from the broadcasting station; collating the authentication information stored in the storing means with the authentication information received by the receiving means; and downloading the software received by the receiving means corresponding to the collating result of the collating means.

Another aspect of the present invention is a method of obtaining software with a terminal apparatus that receives a program along with authentication information with which each user is authenticated for a viewing license from a broadcasting station and reproduces the program with the authentication information, the method comprising the steps of: pre-storing the authentication information; receiving the authentication information from the broadcasting station; collating the authentication information stored in the storing means with the authentication information received by the receiving means; and downloading the software or data from a server that stores the software or data corresponding to the collating result of the collating means.

Another aspect of the present invention is a method of obtaining software with a terminal apparatus that receives a program along with authentication information with which each user is authenticated for a viewing license from a broadcasting station and reproduces the program with the authentication information, the method comprising the steps of: pre-storing the authentication information; receiving the authentication information from the broadcasting station; collating the authentication information stored in the storing means with the authentication information received by the receiving means; and downloading the software or data from a removable medium that stores the software or data corresponding to the collating result of the collating means.

Effects of the Invention

According to the present invention, large capacity and high quality software can be downloaded at low cost and high speed.

### BEST MODE FOR CARRYING OUT THE INVENTION

Next, with reference to the accompanying drawings, an embodiment of the present invention will be described.

FIG. 1 is a schematic diagram showing a structure of a system according to an embodiment of the present invention.

As shown in the drawing, according to this embodiment, program data and so forth are transmitted from a broadcasting station 1 to a broadcasting satellite 2 through an uplink. The broadcasting satellite 2 that receives the program data and so forth broadcasts the program data and so forth with a digital terrestrial wave. A ground user terminal 3 receives a digital satellite broadcast wave transmitted from the broadcasting satellite 2 and the user watches a video of the program and listens to sound thereof.

The digital satellite broadcast provides multi channels services of audio, data, and video to non-mobile receiving terminals in offices and homes and mobile receiving terminals such as onboard terminals and portable terminals through an S band satellite. According to this embodiment, software is broadcast with at least one dedicated software download channel to provide the software to the user terminal 3. In addition, according to this embodiment, it is assumed that the user terminal is a PC.

FIG. 2 is a schematic diagram showing a structure of a PC 4 according to this embodiment of the present invention.

As shown in the drawing, the PC 4 is composed of a CPU 5, a main storage unit 6, an auxiliary storage unit 7, a receiving unit 8, and a CAS 9 that are connected through an interface.

The CPU (Central Processing Unit) 5 controls information exchanged among these units through the interface. In addition, the CPU 5 successively reads software that has been read to the main storage unit 6 through the auxiliary storage unit 7 and executes the software.

The main storage unit 6 is a memory that is composed of for example a DRAM and to and from which data can be written and read at high speed. The auxiliary storage unit 7 is a non-volatile memory that permanently stores software that has been broadcast from the broadcasting station 1 and various types of programs and data.

The receiving unit 8 is a unit that receives a broadcast program from the broadcasting station 1 through the broadcasting satellite 2. The receiving unit 8 is mainly composed of an antenna and a tuner (not shown).

The CAS (Conditional Access System) 9 is a system that scrambles a broadcast signal and performs an access control for individual users so that only contracted users can receive the broadcast signal. The CAS 9 identifies each contracted user using an authentication number stored in a CAS card distributed to each contracted user. When the user receives a contracted broadcast program, the CAS 9 reads the authentication number from the CAS card and collates it with an authentication number contained in a received broadcast program to identify him or her as a contracted user. When the user wants to download software, he or she makes a contract with the software vendor to register at the broadcasting station 1 for the authentication number of the CAS card.

According to this embodiment, the receiving unit 8 and the CAS 9 may be built in the PC 4. Instead, as shown in FIG. 2, when the PC is denoted by reference numeral 10 and the receiving unit and the CAS are denoted by reference numeral 11, the receiving unit and the CAS may be dependent from the PC as long as they exchange information thereamong.

In this case, as shown in FIG. 3A, the receiving unit 8 and the CAS 9 may be build in a satellite broadcast receiving terminal 12 that can receive and reproduce a satellite broadcast program. Instead, as shown in FIG. 3B, the receiving unit 8 and the CAS 9 may be build in a PC card 13. The satellite broadcast reception terminal 12 is connected to the PC 4 through for example a USB (Universal Serial Bus). On the other hand, the PC card 13 is attached to a PC card slot of the PC 4. Instead, a CF (Compact Flash (registered trademark) may have functions of the receiving unit 8 and the CAS 9.

FIG. 4 is a schematic diagram shows a hierarchical structure of hardware and software that operate on the PC 4 according to this embodiment.

As shown in the drawing, on the PC 4, hardware 14, firmware 15, an OS (Operating System) 16, middleware 17, and application software 18 hierarchically operate in the order of lower hierarchical levels.

The hardware 14 is a physical substance such as the foregoing CPU 5, main storage unit 6, and auxiliary storage unit 7.

The firmware 15 is generally a device driver, a BIOS (Basic Input Output System), and so forth. The firmware 15 is a program that controls the operations of a keyboard, a display unit, a communication control unit, a peripheral unit, and so forth of the hardware 14. The firmware 15 is stored in the hardware 14 as a read-only memory (ROM) or a rewritable memory (flash memory).

The OS 16 is fundamental software that manages the hardware 14 such as the foregoing CPU unit 5, main storage unit 6, and auxiliary storage unit 7 and that processes a common portion in various types of application software 18.

The middleware 17 is software that provides more higher and practical functions to the application software 18 than the OS 16. The middleware 17 is intermediate software between the OS 16 and the application software 18. The functions of the receiving unit 8, the CAS 9, and their interface according to this embodiment are not contained in a regular PC. Thus, these functions need to be additionally installed. If they were separately installed, an interface of the firmware 15, the OS 16, and the application software 18 would become complicated. If there were a bug, it would be very difficult to locate it. To prevent such problems, the middleware 17 contains these functions. The interface to the OS 16 and the application software 18 are standardized.

The application software 18 is software that accomplish a prejudged object for example creating a document or a table, or reproduces music.

According to this embodiment, five hierarchical levels of hardware and software share these functions to prevent the operations of the PC 4 from becoming complicated.

Next, an operation of the PC 4 having such a structure will be described.

FIG. 5 is a flow chart showing processes starting from a download process for software to the PC 4 to an install process.

When the power of the PC 4 is turned on (at ST501), the receiving unit 8 starts receiving a satellite broadcast. A received signal is sent to the CAS 9. The CAS 9 collates the foregoing authentication information contained in the received signal and judges whether the user has made a receiving contact (at ST502). When the judged result denotes that the user is a contracted user (YES at ST502), the CAS 9 judges that the contracted user be a user to which software is downloaded and downloads software contained in the received signal to the CPU 5. The CPU 5 judges whether the software is the application software 18 (at ST505), an upgraded file of the OS 16 (at ST507), or an upgraded file of the firmware 15 (at ST509). Corresponding to the judged result, the CPU 5 installs the application software 18 (at ST506), upgrades the OS 16 (at ST508), or upgrades the firmware 15 (at ST509). When the CAS 9 has judged that the user is not a contracted user (NO at ST503), a normal free broadcast is received (at ST504). When the OS 16 or the firmware 15 is upgraded, the user is asked whether to restart the PC 4 after the update file is installed on a display screen of the PC 4 or the satellite broadcast reception terminal 12 (at ST512). When the user wants to restart the PC 4 (YES at ST512), the PC 4 is restarted (at ST513). When the user does not want to restart the PC 4 (NO at ST512) and the CAS 9 has judged that the user is a contracted user, but not a user to whom software is downloaded (for example, the same software has been already downloaded) at ST505, ST507, or ST509, a normal pay-for-view broadcast is received (at ST511). These processes are repeated until the user turns off the PC 4 (NO at ST514). When the user turns off the power of the PC 4 (YES at ST514), the install process is completed. When a software vendor permits all users to download software free of charge, all users whose authentication information has been registered at the broadcasting station 1 are set as persons to whom software is downloaded. In this case, since the CAS 9 does not need to collate authentication information, authentication process and time can be omitted.

In the foregoing operation, since software is provided by a broadcast, the user can download large capacity and high quality software at low cost and high speed in comparison with the case that it is downloaded through a network such as the Internet. When the user has authentication information, software is passively downloaded along with a broadcast program that is received. Thus, since the user does not need to perform a troublesome operation, the convenience is improved. In addition, with the authentication information, the software vendor can know all users and easily manage information about them.

To smoothly download software, instead of one-way information transmission by a broadcast, the user side sometimes needs to transmit information about the user side to the software vendor side.

Thus, the present invention has information transmitting means for transmitting information from the user terminal 3 to the software vendor along with the foregoing functions of the foregoing embodiment. Next, the case that the foregoing embodiment has information transmitting means will be described.

FIG. 6 is a schematic diagram showing a structure in the case that the PC 4 has the information communication means. For simplicity, similar portions to those of the foregoing embodiment shown in FIG. 2 are denoted by similar reference numerals and their functional description will be omitted.

As shown in FIG. 6, a PC 4 is composed of a CPU 5, a main storage unit 6, an auxiliary storage unit 7, a receiving unit 8, and a CAS 9, their interface, an information transmitting unit 19, and its interface.

The information transmitting unit 19 has a communication function to a cellular phone (including a PHS) and a network connection function to the Internet through an optical cable, a telephone line, a power line, a wireless LAN, or the like. The information transmitting unit 19 may be build in the PC 4. Instead, like the foregoing receiving unit 8 and CAS 9, the information transmitting unit 19 may be a satellite broadcast receiving terminal 12, a PC card 13, or a CF card that is independent from the PC 4. In this case, the information transmitting unit 19 is connected to the PC 4.

According to this embodiment, a broadcast program broadcast from the broadcasting station 1 contains information about an address of the software vendor along with the foregoing software and authentication information. The information about the address includes information about a dial number of a cellular phone of the software vendor or information about a network location (URL or mail address) of the software vendor.

Next, an operation of the information transmitting unit 19 of the PC 4 will be described. FIG. 7 is a flow chart showing processes starting from a download process for software to the PC 4 to an install process in the case that the PC 4 has the information transmitting unit 19. In the drawing, it is assumed that the information transmitting unit 19 transmits information with a communication function to a cellular phone. Similar steps to those of the foregoing embodiment shown in FIG. 5 are denoted by similar reference numerals and their description will be omitted.

As shown in FIG. 7, the CPU 5 judges whether a broadcast program received through the receiving unit 8 and the CAS 9 contains information about the dial number of the cellular phone (at ST701). When the judged result denotes that the broadcast program contains the information (YES at ST701), the CPU 5 sends the information to the information transmitting unit 19. Thereafter, the information transmitting unit 19 dials the dial number and establishes a communication path to the cellular phone of the software vendor (at ST702). When the PC 4 has been restarted after the software has been installed thereto (at ST513), the CPU 5 judges whether the broadcast program contains information about the dial number (at ST703) . When the judged result denotes that the broadcast program contains the information about the dial number (YES at ST703), likewise, the information transmitting unit 19 dials the dial number (at ST704) and establishes a communication path to the cellular phone. After the communication path has been established, when the user inputs prejudged data or automatically, information about the operation state of the installed software is sent from the CPU 5 to the information transmitting unit 19. In addition, the information is transmitted to the cellular phone of the software vendor. The information about the operation state of the software is information that denotes whether the software has been correctly installed or information that denotes whether the operation of the OS 16 is unstable due to the installed application software 18. Before the software is installed, the information to be transmitted may be for example information about a storage capacity for storing the downloaded software and information about the version of the software. After the software has been installed, the information to be transmitted may be for example information about user's satisfaction of the downloaded software. The transmitted information is transmitted to the broadcasting station 1 through the software vendor. For example, additional information and so forth are broadcast to the PC 4.

When the network connection function using an optical cable, a telephone line, a power line, a wireless LAN, or the like (not shown) is used as a function of the information transmitting unit 19, at ST701 and ST702, it is judged whether the received broadcast program contains information about the network location of the software vendor. When the judged result denotes that the received broadcast program contains the information about the network location of the software vendor (YES at ST701 and ST703), the network location is accessed through an optical cable, a telephone line, a power line, a wireless LAN, or the like and then a communication path is established at ST702 and ST704 (the dial number is dialed in FIG. 7). After the communication path has been established, when the user inputs prejudged data or automatically, the information can be transmitted to a mail address, a web site, or the like of the software vendor.

In the foregoing operation, before or after software is downloaded, the user transmits information about himself or herself and information about his or her terminal to the software vendor. As a result, the user can share these information with the software vendor. As a result, software can be more accurately and smoothly downloaded than the foregoing embodiment. In addition, since software is downloaded using a broadcast communication path, large capacity of data can be transmitted at high speed. In addition, as a communication path for a small capacity of information other than software, a communication function for a cellular phone and a network connection function for a network such as the Internet using an optical cable, a telephone line, a power line, a wireless LAN, or the like are auxiliarily used. As a result, information can be very effectively transmitted and received. In addition, the user and the software vendor can mutually understand each other. As a result, software can be more smoothly downloaded than the foregoing embodiment.

As described above, according to the foregoing embodiment, the broadcasting station 1 broadcasts software that the PC 4 needs to download along with authentication information for a user who has the PC 4. The PC that needs to download the software downloads the received software with the authentication information. Thus, large capacity and high quality software can be downloaded at low cost and high speed without need to perform a troublesome operation.

In addition, the broadcasting station 1 transmits a broadcast program contains information about an address of a software vendor. The PC 4 judges whether the broadcast program contains the information about the address. When the judged result denotes that the broadcast program contains the information about the address, prejudged information is transmitted to the address. Thus, the user and the software vendor can share information. As a result, the software can be more accurately and smoothly downloaded than the foregoing embodiment.

It should be noted that the present invention is not limited to the foregoing embodiment. Instead, various modifications can be made.

According to the foregoing embodiment, the user terminal is a PC. However, the present invention may be applied to microprocessor-equipped devices. These devices are for example devices used in train stations (such as automatic ticket gates), medical devices, onboard devices (such as car navigation systems), automatic manufacturing devices, and automatic vending machines.

FIG. 8 is a schematic diagram showing a structure of a microprocessor-equipped device 20. In FIG. 8, similar portions to those in the foregoing embodiment shown in FIG. 6 are denoted by similar reference numerals and their functional description will be omitted.

As shown in FIG. 8, the microprocessor-equipped device 20 is composed of a microprocessor 21, a controlled device 22, a main storage unit 6, an auxiliary storage unit 7, a receiving unit 8, a CAS 9, an information transmitting unit 19, and their interface.

Like the CPU 5 according to the foregoing embodiment, the microprocessor 21 controls information exchange among these devices through the interface. In addition, the microprocessor 21 successively reads software that has been read to the main storage unit 6 through the auxiliary storage unit 7 and executes the software.

The controlled device 22 is a device controlled corresponding to the software. The controlled device 22 is for example a ticket conveying device or the like of a automatic ticket gate.

Like the PC 4, software that operates on the microprocessor-equipped device 20 is a firmware 15, an OS 16, and application software 18. In the same operation as the foregoing embodiment, software is received from the broadcasting station 1. As a result, the application software 18 can be installed and the firmware 15 and the OS 16 can be upgraded. In addition, likewise, the information transmitting unit 19 can transmit information to the software vendor.

In addition, as another embodiment, the user terminal may be a video/audio/text operating device such as a game terminal, an electronic book, an electronic newspaper, or a movie and music reproduction device.

FIG. 9 is a schematic diagram showing a structure of a video/audio/text operating device 23 according to the present invention. In FIG. 9, similar portions to those in the foregoing embodiment shown in FIG. 6 are denoted by similar reference numerals and their functional description will be omitted.

As shown in FIG. 9, the video/audio/text operating device 23 is composed of a microprocessor 21, a multimedia terminal hardware (hereinafter referred to as the MM hardware) 24, a main storage unit 6, an auxiliary storage unit 7, a receiving unit 8, a CAS 9, an information transmitting unit 19, and their interface.

The MM hardware 24 is a device that operates video, audio, and text. The MM hardware 24 is controlled corresponding to software executed on the microprocessor.

Like the PC 4 and the microprocessor-equipped device 20, software that operates on the video/audio/text operating device 23 is firmware 15, an OS 16, and an application software 18. The MM hardware 24 receives software from the broadcasting station 1 in the same manner as the foregoing embodiment. As a result, the application software 18 can be installed and the firmware 15 and the OS 16 can be upgraded. In addition, likewise, the information transmitting unit 19 can transmit information to the software vendor.

In the foregoing embodiment, a satellite broadcast was described. Instead, the present invention can be applied to a terrestrial digital broadcast and a virtual broadcast system on the Internet.

In the foregoing embodiment, software is broadcast on a dedicated software download channel. Instead, software may be broadcast on for example a control channel. Since all users have an opportunity for accessing the control channel, software can be passively provided to users on the terminal side without necessity to access the dedicated channel. In this case, it is preferred that an upgraded file of the operating system and a upgraded file of the firmware be provided through the control channel. This is because the control channel has a relatively small capacity and these software has a relatively small size. Thus, in this case, it is preferred that application software and an OS that have a relatively large size be downloaded on the dedicated software download channel. In addition, on the control channel, particular users may be asked to download software. In this case, the user may access the dedicated software download channel by himself or herself. Instead, the dedicated software download channel may be automatically accessed.

In the foregoing embodiment, software, information about an address of a software vendor, and authentication information are broadcast. As a result, software is installed to the user terminal and information is transmitted. Instead, the broadcasting station 1 may broadcast only authentication information. Software and information about the address of the software vendor may be obtained from another location or a medium.

In this modification, data of the software and information about the address of the software vendor are stored in a server of the software vendor and the broadcasting station transmits only authentication information and the software and the information about the address of the software vendor are downloaded from the server.

FIG. 10 is a schematic diagram showing an outline of a structure of such a system. In the drawing, similar portions to those of the foregoing embodiment shown in FIG. 1 are denoted by similar reference numerals. As shown in FIG. 10, a user terminal 3 receives authentication information from a broadcasting station 1. The user terminal 3 collates the authentication information with own authentication information. When they match, the user terminal 3 accesses a server 25 of a software vendor side through a network 26 such as the Internet and loads the software and information about an address of the software vendor from the server 25. Thereafter, in the same operation as the foregoing embodiment, the software is installed or upgraded. Likewise, an information transmitting unit 19 may transmit information to the software vendor.

When the user terminal 3 is not an information device that has an application execution function unlike a PC or a PDA, after the user terminal 3 loads software and so forth, the information device connected to the user terminal 3 through a network such as a USB or the Internet loads the software and so forth and stores them to the storage unit. Instead, the user terminal 3 may not load the software and so forth. In this case, the user terminal 3 only collates authentication information with own authentication information. When they match, the information device directly accesses the server and loads the software and so forth.

Instead, as another modification, a user terminal 3 may receive only authentication information from a broadcasting station 1. The user terminal 3 may load software and information about an address of a software vendor from a removable medium such as a CD-ROM or a FD.

FIG. 11 shows a modification of which a user terminal 3 loads software and so forth from a CD-ROM. As shown in the drawing, the user terminal 3 receives authentication information from a broadcasting station 1. When the received authentication information matches own authentication information, a CD-ROM 27 that contains data of software, information about an address of a software vendor, and so forth is inserted into a CD-ROM drive 28. The CD-ROM drive 28 loads contents from the CD-ROM 27. Thereafter, in the same operation as the foregoing embodiment, software can be installed or upgraded and the information can be transmitted.

In this case, the user terminal 2 may be equipped with a removable disc drive such as the CD-ROM drive 28. Instead, the removable disc drive may be connected to the user terminal 3 through for example a USB so that they can communicate with each other.

Instead, the removable disc drive such as the CD-ROM drive 28 may have functions of a receiving unit 8 and a CAS 9. In this case, the CD-ROM drive 28 not only loads contents from the disc, but collates authentication information in the preceding stage.

When the user terminal 3 is not an information device such as a PC or a PDA, like the case that the user terminal 3 loads software and so forth from the server 25, after the user terminal 3 loads software and so forth, the information device loads them through a network such as a USB or the Internet and stores them to a storage unit of the information device. Instead, the user terminal 3 may only collate authentication information, not load contents from the disc. When the authentication information matches the own authentication information, the information device may directly load contents from the CD-ROM drive 28.

### BRIEF DESCRIPTION OF THE DRAWINGS

FIG. 1 is a schematic diagram showing an outline of a structure of a system according to an embodiment of the present invention.

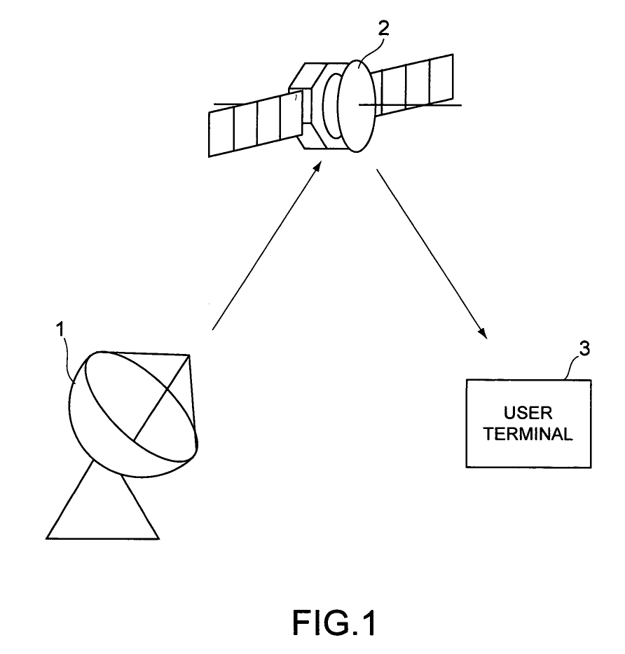

FIG. 2 is a schematic diagram showing a structure of a PC 4 according to an embodiment of the present invention.

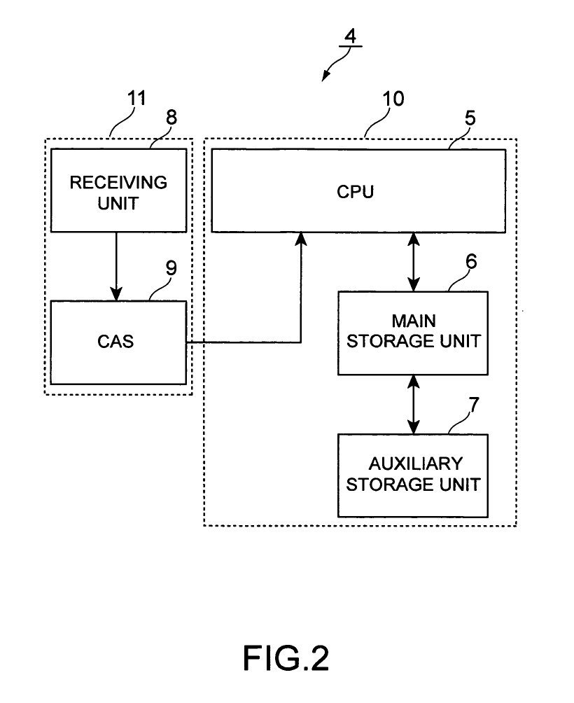

FIG. 3 is a schematic diagram describing a layout of receiving unit 8 and a CAS 9 according to an embodiment of the present invention.

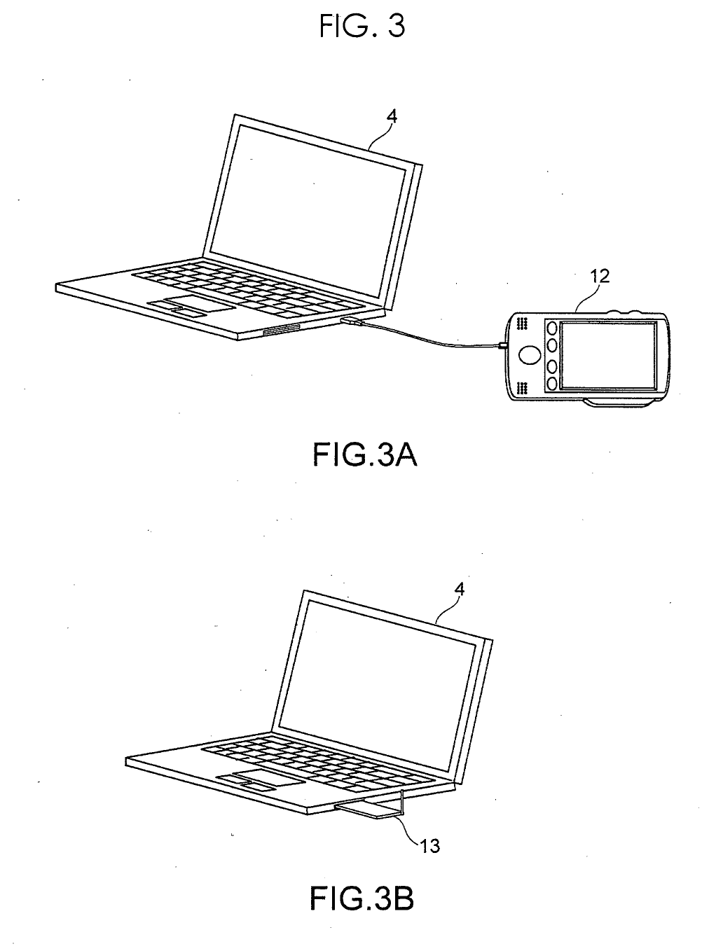

FIG. 4 is a schematic diagram showing a hierarchical structure of hardware and software that operate on the PC 4 according to an embodiment of the present invention.

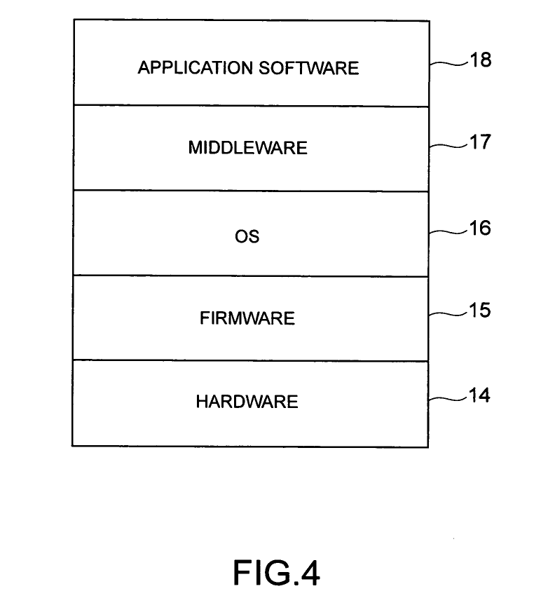

FIG. 5 is a flow chart showing processes starting from a download process for software to the PC 4 to an install process according to an embodiment of the present invention.

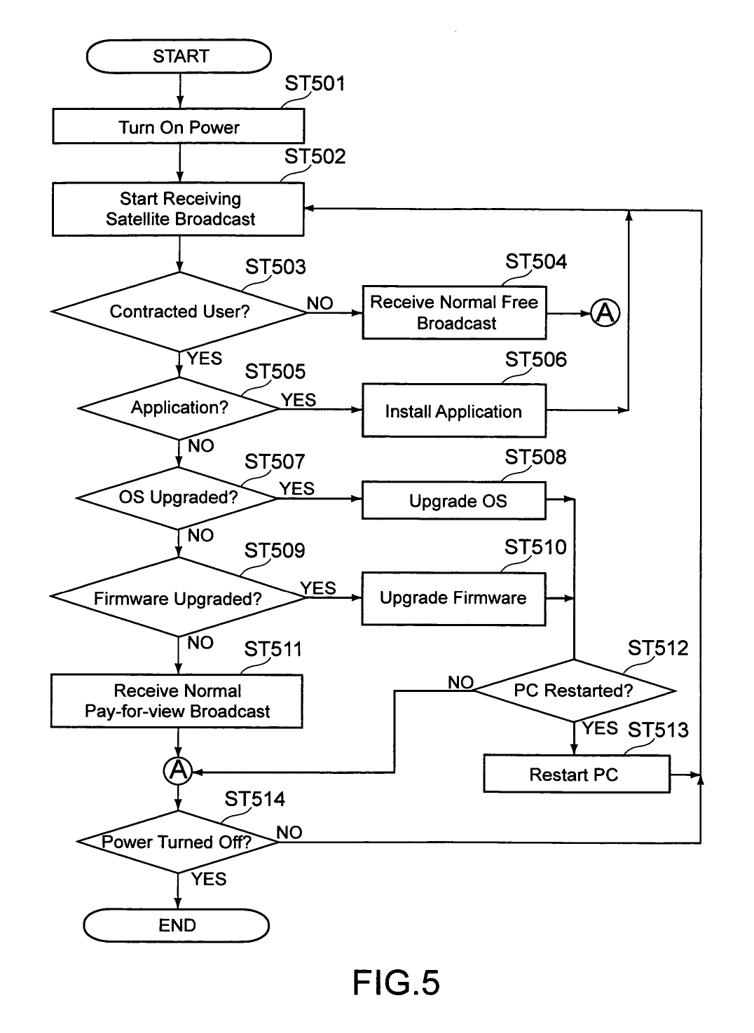

FIG. 6 is a schematic diagram showing a structure in the case that the PC 4 has information communication means.

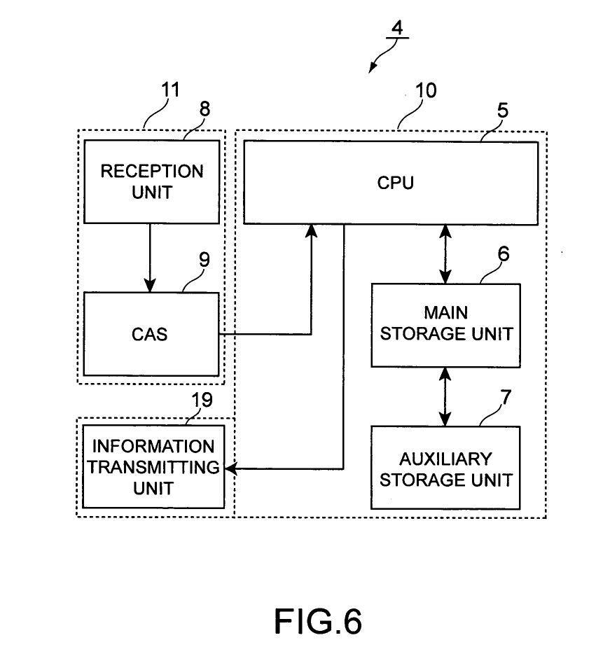

FIG. 7 is a flow chart showing processes starting from a download process for software to the PC 4 to an install process in the case that the PC 4 has an information transmitting unit 19.

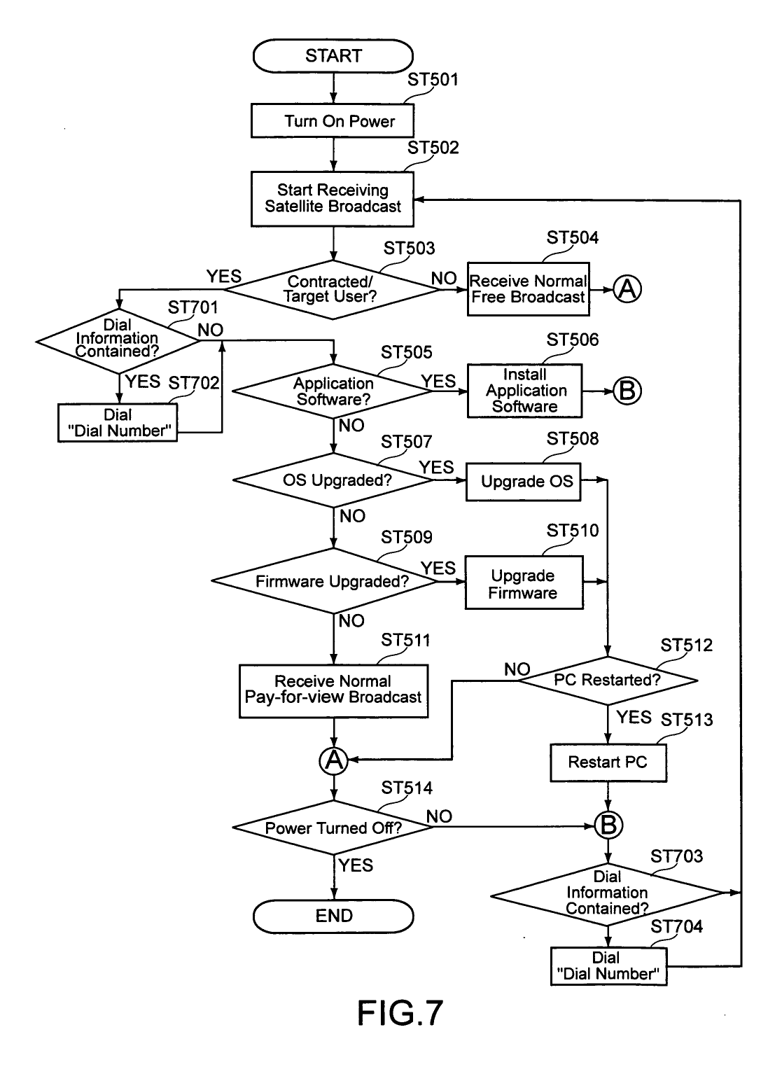

FIG. 8 is a schematic diagram showing a structure of a microprocessor-equipped device 20 according to the present invention.

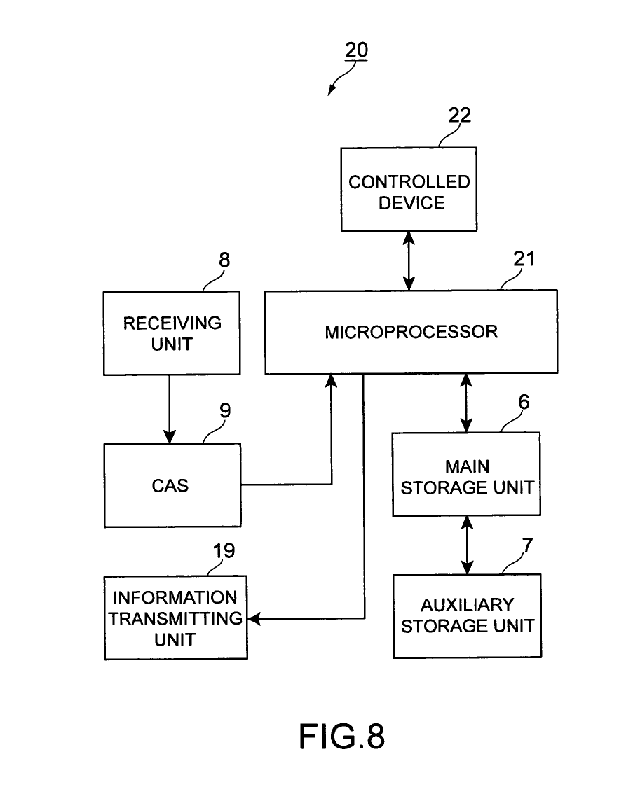

FIG. 9 is a schematic diagram showing a structure of a video/audio/text operating device 23 according to the present invention.

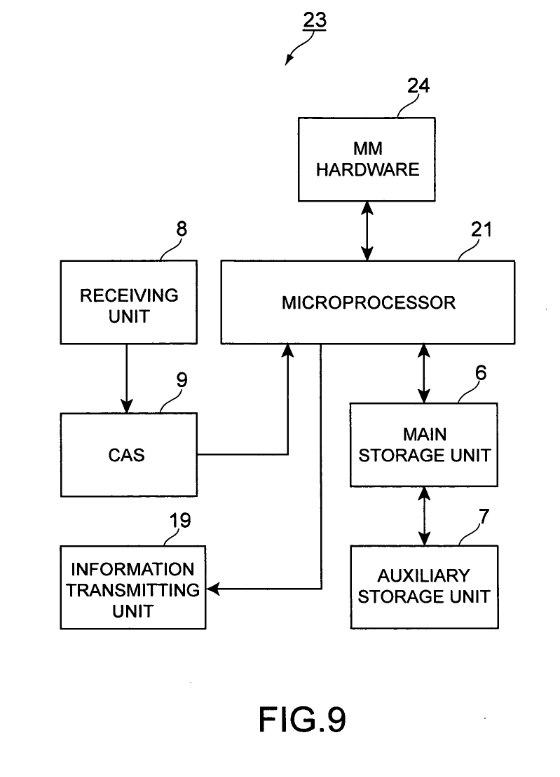

FIG. 10 is a schematic diagram showing a structure of a system according to an embodiment of the present invention.

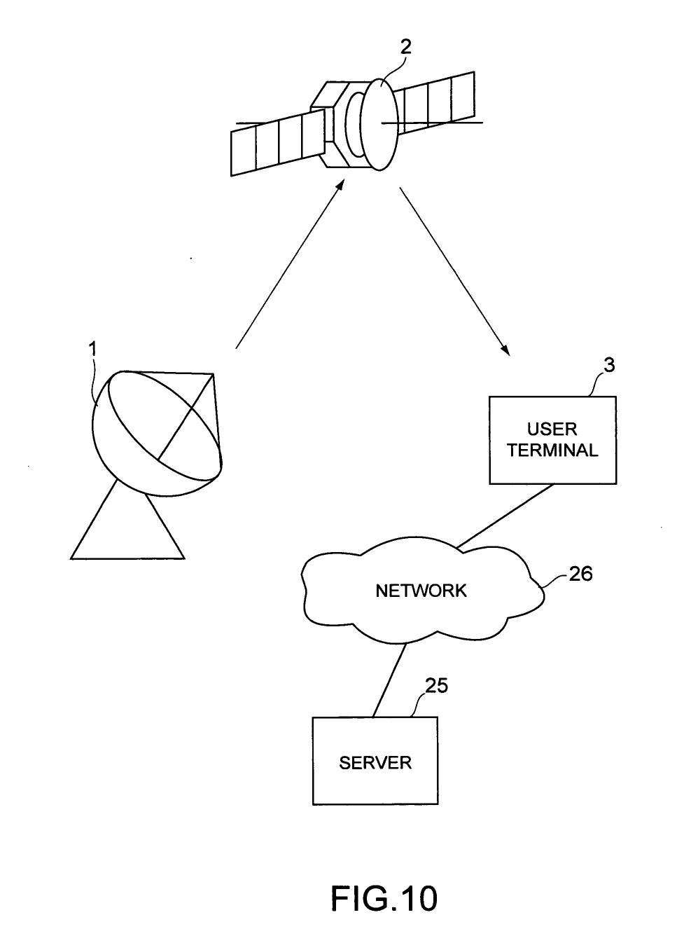

FIG. 11 is a schematic diagram showing the case that the user terminal 3 loads software and so forth from a CD-ROM 27.

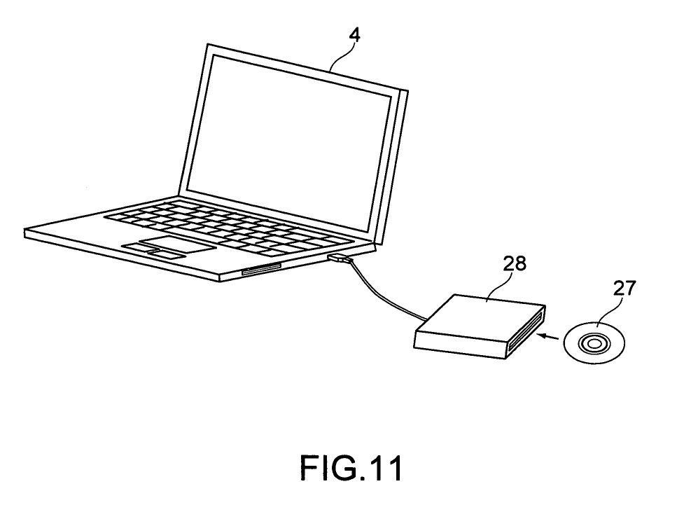

### EXPLANATION OF CODES

1 . . . broadcasting station
2 . . . broadcasting satellite
3 . . . user terminal
4 . . . PC
5 . . . CPU
6 . . . storage unit
7 . . . auxiliary storage unit
8 . . . receiving unit
9 . . . CAS
12 . . . satellite broadcast receiving terminal
13 . . . PC card
14 . . . hardware
15 . . . firmware
16 . . . OS
17 . . . middle ware
18 . . . application software
19 . . . information transmitting unit
20 . . . microprocessor-equipped device
21 . . . microprocessor
22 . . . controlled device
23 . . . video/audio/text operating device
24 . . . MM hardware
25 . . . server
26 . . . network
27 . . . CD-ROM
28 . . . CD-ROM drive

What is claimed is:

1. A software providing method for a system of which a broadcasting station broadcasts a program along with authentication information with which each user is authenticated for a viewing license and a user terminal that has the authentication information reproduces a received program with the authentication information, the method comprising the steps of:
causing the broadcasting station to broadcast software that the user terminal needs to download along with the authentication information of the user; and
causing the user terminal that needs to download the software to download the received software with the authentication information of the user.

2. The software providing method as set forth in claim 1,
wherein the software is at least one of application software, an upgraded file of an operating system, and an upgraded file of firmware of the terminal.

3. The software providing method as set forth in claim 1,
wherein the broadcasting station broadcasts the software so that the user terminal can download the software without the authentication information when the broadcasting station provides free software.

4. The software providing method as set forth in claim 1,
wherein the broadcasting station broadcasts the software that the user terminal needs to download along with the authentication information of the user and information about an address of a software provider, and
wherein the user terminal judges whether the broadcasting station has broadcast the program along with the information of the address of the software provider and when the judged result denotes that broadcasting station has broadcast the program along with the information of the address of the software provider, the user terminal transmits prejudged information to the address of the software provider.

5. The software providing method as set forth in claim 4,
wherein the information of the address of the software provider is information about a dial number of a cellular phone or a network address.

6. The software providing method as set forth in claim 4,
wherein the prejudged information includes at least a piece of information about a storage capacity for storing the downloaded software, information about a version of the software, information about an operation state of the software that has been downloaded, and information about user's satisfaction for the software that has been downloaded.

7. A software providing method for a system of which a broadcasting station broadcasts a program along with authentication information with which each user is authenticated for a viewing license and a user terminal that has the authentication information reproduces a received program with the authentication information, the method comprising the steps of:
causing the broadcasting station to broadcast the authentication information of the user that allows him or her to load the software or data from a server that stores the software or the data to the user terminal and to use the software or data; and
causing the user terminal to load the software or data from the server with the authentication information of the user broadcast from the broadcasting station so that the user terminal can use the software or data.

8. A software providing method for a system of which a broadcasting station broadcasts a program along with authentication information with which each user is authenticated for a viewing license and a user terminal that has the authentication information reproduces a received program with the authentication information, the method comprising the steps of:
causing the broadcasting station to broadcast the authentication information of the user that allows him or her to load the software or data from a server that stores the software or the data to the user terminal and to use the software or data; and
causing an information device connected to the user terminal to load the software or data from the server and store the software or data to a storage unit of the information device when authentication information stored in the user terminal matches authentication information that the user terminal has received.

9. A software providing method for a system of which a broadcasting station broadcasts a program along with authentication information with which each user is authenticated for a viewing license and a user terminal that has the authentication information reproduces a received program with the authentication information, the method comprising the steps of:
causing the broadcasting station to broadcast the authentication information of the user that allows him or her to load the software or data from a removable medium that stores the software or the data to the user terminal and to use the software or data; and
causing the user terminal to load the software or data from the removable medium with the authentication information of the user broadcast from the broadcasting station so that the user terminal can use the software or data.

10. A software providing method for a system of which a broadcasting station broadcasts a program along with authentication information with which each user is authenticated for a viewing license and a user terminal that has the authentication information reproduces a received program with the authentication information, the method comprising the steps of:
causing the broadcasting station to broadcast the authentication information of the user that allows him or her to load the software or data from a removable medium that stores the software or the data to the user terminal and to use the software or data; and
causing an information device connected to the user terminal to load the software or data from the removable medium and store the software or data to a storage unit of the information device when authentication information stored in the user terminal matches authentication information that the user terminal has received.

11. A software providing system of which a broadcasting station broadcasts a program along with authentication information with which each user is authenticated for a viewing license and a user terminal that has the authentication information reproduces a received program with the authentication information,
wherein the broadcasting station comprises:
broadcasting means for broadcasting software that the user terminal needs to download along with the authentication information of the user, and
wherein the user terminal comprises:
receiving means for receiving a broadcast program along with the software and the authentication information with which the software is downloaded; and
downloading means for downloading the software with the authentication information of the user.

12. The software providing system as set forth in claim 11,
wherein the software is at least one of application software, an upgraded file of an operating system, and an upgraded file of firmware of the terminal.

13. The software providing system as set forth in claim 11,
wherein the broadcasting station further comprises:
means for broadcasting the software so that the user terminal can download the software without the authentication information when the broadcasting station provides free software.

14. The software providing system as set forth in claim 11,
wherein the broadcasting means broadcasts the software that the user terminal needs to download along with the authentication information of the user and information about an address of a software provider, and
wherein the user terminal further comprises:
judging means for judging whether the program has been broadcast along with the information of the address of the software provider, and
transmitting means transmitting prejudged information to the address of the software provider when the judged result denotes that the program has been broadcast along with the information of the address of the software provider.

15. The software providing system as set forth in claim 14,
wherein the information of the address of the software provider is information about a dial number of a cellular phone or a network address.

16. The software providing system as set forth in claim 14,
wherein the prejudged information includes at least a piece of information about a storage capacity for storing the downloaded software, information about a version of the software, information about an operation state of the software that has been downloaded, and information about user's satisfaction for the software that has been downloaded.

17. A terminal apparatus that receives a program along with authentication information with which each user is authenticated for a viewing license from a broadcasting station and reproduces the program with the authentication information, comprising:
storing means for pre-storing the authentication information;
receiving means for receiving a broadcast program along with software and the authentication information from the broadcasting station;
collating means for collating the authentication information stored in the storing means with the authentication information received by the receiving means; and
downloading means for downloading the software received by the receiving means corresponding to the collating result of the collating means.

18. The terminal apparatus as set forth in claim 17,
wherein the software is at least one of application software, an upgraded file of an operating system, and an upgraded file of firmware of the terminal apparatus.

19. The terminal apparatus as set forth in claim 17,
wherein the receiving means receives the broadcast program along with the software, the authentication information, and information about an address of a software provider, and
wherein the terminal apparatus further comprises:
judging means for judging the broadcast program has been received along with the information about the address of the software provider; and
transmitting means for transmitting prejudged information to the address of the software provider when the judged result denotes that the broadcast program has been received along with the information about the address of the software provider.

20. The terminal apparatus as set forth in claim 19,
wherein the information of the address of the software provider is information about a dial number of a cellular phone or a network address.

21. The terminal apparatus as set forth in claim 14,
wherein the prejudged information includes at least a piece of information about a storage capacity for storing the downloaded software, information about a version of the software, information about an operation state of the software that has been downloaded, and information about user's satisfaction for the software that has been downloaded.

22. A terminal apparatus that receives a program along with authentication information with which each user is authenticated for a viewing license from a broadcasting station and reproduces the program with the authentication information, comprising:
storing means for pre-storing the authentication information;
receiving means for receiving the authentication information from the broadcasting station;
collating means for collating the authentication information stored in the storing means with the authentication information received by the receiving means; and
loading means for loading software or data from a server that stores the software or data corresponding to the collating result of the collating means.

23. A terminal apparatus that receives a program along with authentication information with which each user is authenticated for a viewing license from a broadcasting station and reproduces the program with the authentication information, comprising:
storing means for pre-storing the authentication information;
receiving means for receiving the authentication information from the broadcasting station;
collating means for collating the authentication information stored in the storing means with the authentication information received by the receiving means; and
loading means for loading software or data from a removable medium that stores the software or data corresponding to the collating result of the collating means.

24. A method of obtaining software with a terminal apparatus that receives a program along with authentication information with which each user is authenticated for a viewing license from a broadcasting station and reproduces the program with the authentication information, the method comprising the steps of:
pre-storing the authentication information;
receiving a broadcast program along with software and the authentication information from the broadcasting station;
collating the authentication information stored in the storing means with the authentication information received by the receiving means; and
downloading the software received by the receiving means corresponding to the collating result of the collating means.

25. A method of obtaining software with a terminal apparatus that receives a program along with authentication information with which each user is authenticated for a viewing license from a broadcasting station and reproduces the program with the authentication information, the method comprising the steps of:
pre-storing the authentication information;
receiving the authentication information from the broadcasting station;
collating the authentication information stored in the storing means with the authentication information received by the receiving means; and
loading the software or data from a server that stores the software or data corresponding to the collating result of the collating means.

26. A method of obtaining software with a terminal apparatus that receives a program along with authentication information with which each user is authenticated for a viewing license from a broadcasting station and reproduces the program with the authentication information, the method comprising the steps of:
pre-storing the authentication information;
receiving the authentication information from the broadcasting station;
collating the authentication information stored in the storing means with the authentication information received by the receiving means; and
loading the software or data from a removable medium that stores the software or data corresponding to the collating result of the collating means.
